(19) United States
(12) Patent Application Publication
(10) Pub. No.: US 2016/0295876 A1
(43) Pub. Date: Oct. 13, 2016

(54) COFFEE PRODUCT

(71) Applicant: KRAFT FOOFS R & D, INC., Deerfield, IL (US)

(72) Inventor: Abigail Elizabeth Smith, Reading (GB)

(21) Appl. No.: 14/654,822

(22) PCT Filed: Nov. 7, 2014
(86) PCT No.: PCT/IB2014/002513

§ 371 Date: Jun. 22, 2015

(30) Foreign Application Priority Data
Nov. 19, 2013 (GB) 1320377.3
Jan. 21, 2014 (GB) 1400957.5

(51) Int. Cl. A23F 5/08; A23F 5/46; A23F 5/40

(52) U.S. Cl. CPC A23F 5/08; A23F 5/405; A23F 5/46

(57) ABSTRACT

The present invention relates to a process for the manufacture of a roast and ground coffee powder, the process comprising the steps of: • mixing roast and ground coffee with additional coffee oil; and • roller-grinding the mixture to a roast and ground coffee particle size having a D90 of 80 microns or less.

This disclosure relates to the preparation of a finely ground coffee material. This coffee is ground to such an extent that it is not typically suitable for use alone in beverage preparation: it is finer than a typical Turkish grind. However, this fine grind is a useful additive for recently developed instant coffee products and other beverage powders that contain ground coffee particles.

There are a number of instant coffee products available on the market which seek to more accurately simulate the coffee beverages produced in coffee shops from roasted coffee beans. In order to provide an improved organoleptic experience, these instant coffee products are typically formed of spray- or freeze-dried instant coffee, together with finely ground roasted coffee particles. These particles simulate the fine material which is included in authentic coffee beverages during an extraction process and provide an improved depth of flavour.

One example of such a product is Millicano®. Millicano® coffee is prepared by mixing an aqueous coffee extract with finely ground roasted coffee particles. This mixture is then freeze-dried to provide an instant coffee containing the fine particles. By fine particles it is meant particles having an particle size (D90) of less than 100 microns. The particles typically used for Millicano® coffee have a D90 of less than 60 microns and are prepared by jet milling. Jet milling is expensive and can cause a loss of aroma due to the expression of oils from the coffee during grinding. A Millicano coffee may be manufactured as described in GB2482032.

There are also other products are on the market which simply add a fine coffee to pre-manufactured instant coffee particles. Such products suffer from a number of disadvantages including unwanted separation and settling during storage and, typically, use larger particles which lead to a gritty sensation in the mouth and sedimentation in the cup.

EP0560609 discloses the used of a colloidal roasted coffee as an aromatiser additive for soluble coffee. Roast and ground coffee is mixed with an oil and then wet-milled in a ball mill. U.S. Pat. No. 3,625,704 discloses instant coffee flakes made by roller milling soluble coffee powder. The milling apparatus involves a single pair of rollers and produces a large final flakes size. Both disclosures seek to improve the flavour of soluble coffee, but are silent on how to reduce the cost of fine grinding compared to jet milling and improve mouthfeel/texture.

Accordingly, it is desirable to provide an improved method for preparing the additive for such instant coffees and/or tackle at least some of the problems associated with the prior art or, at least, to provide a commercially useful alternative thereto.

Accordingly, in a first aspect the present disclosure provides a process for the manufacture of a roast and ground coffee powder, the process comprising the steps of:
mixing roast and ground coffee with additional coffee oil; and
roller-grinding the mixture to a roast and ground coffee particle size having a D90 of 80 microns or less.

Preferably there is provided a process for the manufacture of an additive for soluble coffee, the process comprising the steps of:
mixing roast and ground coffee with additional coffee oil; and
roller-grinding the mixture to a roast and ground coffee particle size having a D90 of 80 microns or less.

The present invention will now be further described. In the following passages different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

While the following disclosure focuses on the use of the roast and ground coffee powder as an additive for soluble coffee, it should be appreciated that the powder can also be used as an additive for other beverage powders. Exemplary beverage powders include milk powder, chocolate powder, creamer powder, tea powder, or a combination of two or more thereof.

While the following disclosure refers to the roast and ground coffee powder as an additive, it could equally be used alone as a foodstuff or beverage ingredient.

The product of roller-grinding is a suitable additive for a soluble coffee. This additive can be used to prepare a Millicano-style beverage.

The additive and the starting roast and ground coffee are discussed herein in terms of the particle size distribution. As will be appreciated, any grinding process will lead to a distribution of particle sizes and this is particularly the case with coffee beans, due to the hard nature of the beans and the random fragmentation that occurs during grinding. In order to characterise the particle size distribution, the grind of the beans is discussed in terms of the D10, D50 and D90. These terms are well known in the art and can be readily determined using known apparatus and methods.

The measurement techniques for particle sizes is laser diffraction and is based on ISO 13320:2009. For the pre-ground roast and ground coffee sizes the measurement is taken by dispersion in air. For the roller refined product the measurement is taken in an oil dispersant. This is particularly suitable because it avoids unwanted readings relating to the droplet size of the coffee oil—this dissolves in the oil dispersant. Furthermore, it is considered that using the oil dispersant allows any agglomerated particles to separate to give a greater accuracy.

The method used herein relies on a Malvern diffraction unit in oil.

The value of D50 is the log-normal distribution median diameter: the average particle diameter by volume. The values of D10 and D90 are respectively the values for which 10% and 90% by volume of the particles are finer.

An additive for a beverage powder, such as soluble coffee, as defined herein comprises finely ground roasted coffee particles. These are preferably to be used as a minor portion of a beverage powder, such as soluble coffee. That is, the additive is preferably used in an amount of less than 50 wt %, preferably less than 20 wt %, preferably at least 1 wt %, more preferably from 5 wt % to 15 wt %, and most preferably from 6 to 10 wt %. The use of roasted coffee particles in this way is well known.

The process comprises the steps of mixing roast and ground coffee with additional coffee oil. Additional coffee oil is coffee oil above and beyond that already present in the roast and ground coffee. This is preferably performed to form a paste of the roasted coffee. Suitable equipment for mixing is well known in the art and any blending device suitable for handling viscous pastes would be suitable.

The roast and ground coffee may be provided as a blend of different beans (Arabica or Robusta, for example) and/or differently roasted beans. Suitable roasting degrees for coffee are well known in the art to allow the provision of good tasting coffee beverages.

The roast and ground coffee which is the starting material preferably has a particle size having a D50 of from 0.2 to 1.5 mm, more preferably from 0.25 to 1 mm, most preferably from 0.3 to 0.8 mm. That is, the coffee beans are initially ground to provide a sufficient surface area to be coated with the additional oil.

The additional oil is any oil derived from coffee beans. This oil can be pressed roasted coffee bean oil. For efficiency, the coffee oil is preferably a waste coffee oil and/or oil extracted from spent coffee beans. However, oil obtained from freshly roasted beans or partially extracted beans can also be used. An improved depth of flavour can also be achieved by using aromatisation processes so that the coffee oil includes one or more added aroma compounds. Such techniques are well known in the art.

The mixture comprising roasted ground coffee and additional coffee oil is then roller-ground to a roast and ground coffee particle size having a D90 of 80 microns or less. The grinding causes a reduction in the particle size of the coffee and the additional oil serves as a grinding aid and is absorbed into the finer coffee particles.

In order to deliver a smooth, espresso-like experience, the additive should preferably contain substantially no particles of greater than 80 microns in size, preferably no more than 60 microns. Accordingly, the roller refined coffee product should therefore have a D90 particle size of at most 80 microns or less in order that the particles of ground coffee are not readily detectable in a coffee beverage, either by tasting the particles in the mouth, or by seeing a layer of sediment at the bottom of the cup.

Preferably the mixture is roller-ground to a roast and ground coffee particle size having a D90 of less than 60 microns, preferably from 25 to 60 microns, preferably from 30 to 50 microns. That is, there are very fewer undesirable larger particles which form sediment on the bottom of a beverage. Preferably the mixture is roller-ground to a roast and ground coffee particle size having a D50 of from 5 to 30 microns, preferably 10 to 20 microns. It has been found through experimentation that this particle size provides a balance between a loss of flavour resulting from the fine grinding and a fine size which contributes to the flavour without forming sediment or being undesirably visible in suspension. Preferably the mixture is roller-ground to a roast and ground coffee particle size having a D10 of from 0.1 to 10 microns, preferably 1 to 5 microns. This avoids the presence of two much dust. The finer particles tend to be entrained into foam on a final beverage and the presence of too much fine material can spoil its appearance.

Preferably the roller grinder uses smooth surfaced rolls. Unlike the roughened plates used in a two-roll refiner to break whole coffee beans down to approx. 500 microns in size, these smooth rolls provide a narrow particle size distribution at the fine desired sizes.

Preferably the roller-grinding is performed using two or more smooth rollers, preferably with three or more smooth rollers. At a small scale, a three roller refiner can be used, but at commercial scale a five roll refiner is likely to be more viable. Such refining apparatus is well known in the field of chocolate manufacture. These machines are used to make the chocolate very smooth. It is considered that the paste formed of the roast and ground coffee would typically be thicker than might be desired for chocolate processing.

It is further noted that the step of mixing roast and ground coffee with additional coffee oil may further comprises mixing with a further beverage ingredient. The benefits of such additions include the modification of flavour, texture or aroma attributes of a soluble coffee, and the option for extending the product range to include coffee mixes, sweetened coffees, hot chocolates or other powdered beverages with an oil component. This process provides an ideal opportunity to incorporate very fine amounts of further beverage ingredients into a soluble coffee product. For example, flavourings, such as chocolate, vanilla, strawberry, mint, hazelnut and the like, can be incorporated into the additive. Alternatively chemical foaming ingredients, which are well known in the art, can be incorporated at this point. As will be appreciated, foaming ingredients which rely on trapped air are not suitable for grinding since the air will be lost. Other ingredients such as milk powder, sugar, sweeteners or chocolate powder can also be included and combinations of two or more of these further beverage ingredients may, of course, also be used.

Preferably the mixing ratio of roast and ground coffee to additional coffee oil is from 9:1 to 3:2, more preferably from 6:1 to 3:1, preferably about 4:1. This ratio of mixing ensures that a suitable mixture is obtained for the grinding step. If there is too little oil then there can be flavours lost from the coffee. If there is too much oil then there is a risk of oil slicks forming on the final beverage. The ratio is by weight.

According to a second aspect there is provided an additive for a beverage powder, preferably soluble coffee, obtainable by the process of any of the preceding claims. As will be appreciated, the additive can be distinguished from other such additives since these are neither so finely ground nor contain the additional coffee oils.

According to a third aspect there is provided a process for the manufacture of a roast-and-ground-coffee-containing beverage powder, the process comprising the steps of:
(A) mixing an additive as described herein with a beverage powder; or
(B) mixing an additive as described herein with an aqueous beverage formulation to form a mixture and drying the mixture.

The roast-and-ground-coffee-containing beverage powder is preferably soluble coffee, milk powder, chocolate powder, creamer powder, tea powder, or a combination of two or more thereof.

To form a soluble coffee powder using process (B), the aqueous beverage formulation will be a coffee extract. Equally, for a milk powder, the aqueous beverage formulation will be milk.

The step of mixing the additive as discussed herein with a beverage powder is less preferred since it is difficult to achieve thorough mixing and there is a risk of separation.

Preferably the step of drying the mixture is spray-drying or freeze-drying. Freeze-drying is especially preferred as this allows the production of a high quality final product. The process preferably further comprises a step of packaging the soluble coffee. Typical containers for the product will be jars, pots and sachets, although it is also considered that the soluble coffee can be used in beverage preparation machines, held in capsules, pods or cartridges, optionally in combination with further ingredients such as creamers and the like.

The present inventors have found that the method of the present invention provides an effective method of arriving at an additive for beverage powders, instant coffee powders and formulations containing instant coffee. Moreover, the inventors have found that there are a number of advantages associated with the method described herein.

As will be appreciated, a number of grinding techniques are known for coffee beans, and various cutters and roller devices are used to prepare a finely ground coffee. However, as finer grinding is desired, it has been found preferable for the coffee beans to be kept chilled or cooled during grinding to minimise any undesirable scorching of the beans. The inventors have, however, found that the use of the coffee oil additive and the formation of a paste actually allows the grinding to be carried out at ambient temperature. That is, from about 10 to about 35° C., preferably about 15 to about 25° C. The ambient temperature of the process is desirable and, if necessary, can be controlled to maintain it. In trials, no active heating was required to achieve this. It is considered that the aroma components are retained in the added oil. Temperature control could be used during pasting and refining to modulate the viscosity of the coffee oil and modify the consistency of the coffee paste. The benefit of using ambient temperatures for coffee milling is that natural aromatic compounds that could be easily driven off or damaged by high milling temperatures are retained in the milled coffee product.

It is also known to reduce the size of particles through the use of roller grinding. Indeed, it is common to use paired rollers to grind coffee to flakes, such as described in EP0010810. In this application coffee is flaked to a size of about 500 microns using rollers. However, roller techniques have not been used to reduce coffee to these fine sizes for use as an additive in soluble coffee.

The process of reducing the size of materials to fine (<100 microns) particles by roller refining is widely used in other industries, such as in the chocolate industry. In the chocolate industry a paste is made with powdered ingredients and fats until the paste has the consistency of wet sand. Only at this consistency will the material pass through the rollers efficiently and the intended level of particle size reduction be achieved. However, in the field of coffee grinding the coffee is not provided as a paste. Instead coffee is conventionally dry ground. Indeed, were water to be added then certain volatile flavour components might be lost.

One of the disadvantages of jet milling, which achieves a comparable particle size, is that the coffee being ground expresses oil. During jet milling of roast coffee, a soluble coffee powder is required as a milling aid to prevent the oil expressed from beans during milling causing blockages in the equipment. It is theorised that this serves to absorb the oil and reduce the formation oil slicks on the final beverage. Accordingly the final additive contains approximately half finely ground coffee and half instant coffee.

The inventors have found that by roller milling with added oil it is possible to form a fine paste and achieve the requisite fine particle size. However, surprisingly, the oil is incorporated into the particles and does not form slicks on the final product, as would be expected from the jet milling process. Accordingly, fine refining as described herein provides the fine particle size of jet milling without the 50 wt % of instant coffee.

The use of a roller refiner system for particle size reduction differs from other known coffee milling techniques in that it enables the incorporation of oil. It has been found that oil is a necessary addition for effective processing of pre-ground coffee through the roller refiner. Applying this principle to coffee, a relatively high level of oil is required to achieve efficient processing. This level would not be processable by the conventional soluble coffee manufacturing process due to issues of oil stability, but in this method the oil intimately coats the roast coffee particles, and is delivered into the coffee brew as stable oil, not forming an oil slick at the surface of the brew. This is especially the case where the roller refined product is added to a coffee extract and mixed sufficiently to disperse the particles prior to drying.

In addition, there are several benefits of incorporating additional coffee oil into a soluble coffee product. These include:

(i) coffee oil can be used as a flavour carrier, and as such its incorporation into a soluble coffee drink can facilitate flavour and aroma modifications and enhancement;
(ii) distribution of stable oil in beverages like coffee is believed to be responsible for conferring additional mouthfeel attributes such as body/creaminess; and
(iii) the incorporation of coffee oil may serve to reduce product cost since coffee oil is otherwise a waste product.

The present invention could use a single step refining process, or a two-step process where a portion of the oil could be retained until after the material has been passed through the refiner once. Preferably a two-step process is used to ensure sufficient particle size reduction. A single step process can typically only achieve a D90 of 50-60 microns, which can result in sedimentation of particles in a brew. It is envisioned that an industrial version of a two-step process on a 3-roll refiner would be pasting followed by a 2-roll pre-refining, then a 5-roll refining.

According to a further aspect, there is provided a method of preparing a beverage, the method comprising adding a beverage medium to the roast-and-ground-coffee-containing beverage powder, preferably soluble coffee, manufactured described herein. Preferably the beverage medium is hot water or milk.

The roast and ground coffee powder is suitable for use as an additive in non-beverage applications. For example, the powder may be incorporated into a dessert, ice-cream, sauce, chocolate, mousse or biscuit dough. The additive would provide a unique mouth-feel and flavour.

The process may further comprise agglomerating the beverage powder and/or forming the beverage powder into a tablet. Methods for agglomerating and forming tablets are well known in the art. A tablet may suitable be formed by compression and/or heating. Desirably a tablet will be a suitable size to form a single serving of beverage when reconstituted.

The invention will now be described in relation to the following non-limiting figures, in which:

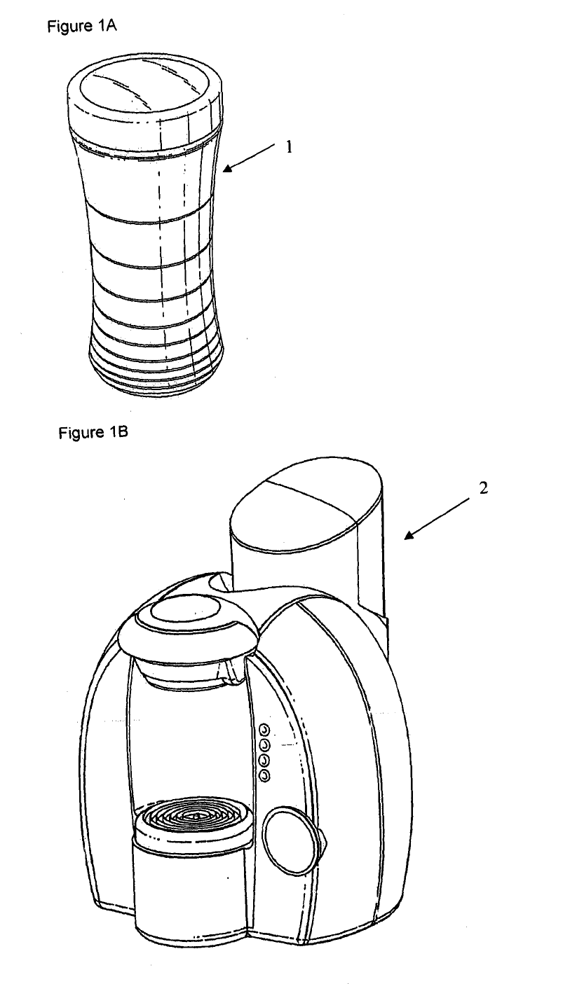

FIG. 1A shows a container 1, suitable for holding an instant coffee composition as disclosed herein.

FIG. 1B shows a coffee beverage preparation system 2.

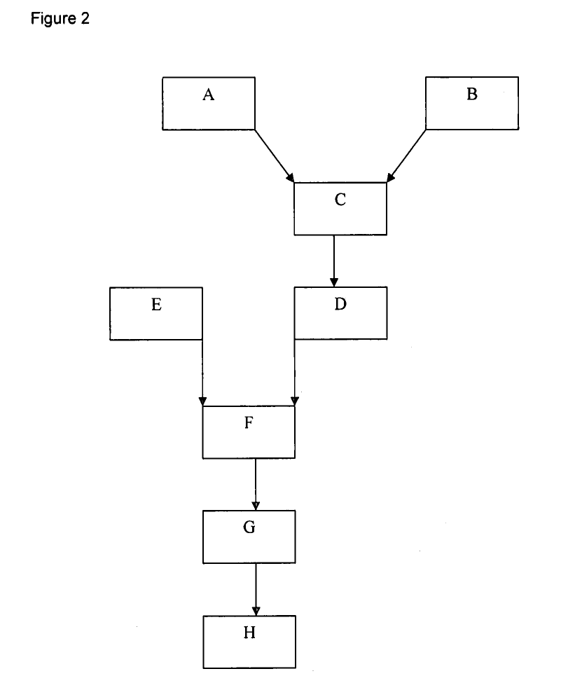

FIG. 2 shows a flowchart of the steps followed to produce a soluble coffee containing the additive as discussed herein.

As shown in FIG. 2, roast and ground coffee beans (A) are added to additional coffee oil (B) and mixed in a mixer (C). The mixture is transferred to a roller-grinder (D) with smooth roller pairs and ground to form an additive. The additive is passed to a further mixer (F) containing a liquid coffee extract (E). This second mixture is then freeze-dried in a freeze-dryer (G) and then packaged in a packaging machine (H).

The invention will now be described in relation to the following non-limiting examples.

### EXAMPLE 1

### Production of Roller Refined Coffee Flakes

In this Example, finely ground coffee particles are produced using a small laboratory-scale 3 roll refiner.

Roasted Arabica coffee beans were pre-ground to a mean particle size of 280 μm and combined with cold-pressed coffee oil from Arabica beans at a ratio of 82.5% coffee beans to 17.5% coffee oil. These two components were mixed for five minutes in a Hobart mixer at a low speed and at ambient temperature (around 20° C.).

The resulting mixture was passed through a Buhler 3-roll refiner with smooth rolls. The rollers were water cooled at a temperature of 35° C. to ensure the temperature did not rise, and roller pressure was set at 10 bar. Gap settings between both pairs of rollers were set using the clock face control at 12:15.

The resulting flake-like product was returned to the Hobart mixer and combined with a further amount of coffee oil, to create a paste with the composition of 80% coffee beans and 20% coffee oil. The paste was mixed for five minutes in the Hobart mixer at a low speed and at ambient temperature.

The resulting paste was passed through the three-roll refiner for a second time, again using 10 bar pressure on the rollers, but reducing the gap setting to 12:02 between both pairs of rollers.

Using the above process, the particle size distribution of the coffee particles was D90<58 μm, D50<19 μm and D10<3.2 μm.

These particles were found to be an ideal replacement for the finely ground material used in Millicano. In particular, the presence of the added oil was found to provide a desirable full flavour to the coffee.

### COMPARATIVE EXAMPLE

In this example, finely ground coffee particles are produced using a small laboratory-scale 3 roll refiner, but an acceptable degree of particle size reduction is not achieved.

Roasted Arabica coffee beans were pre-ground to a mean particle size of 1.5 mm and combined with cold-pressed coffee oil from Arabica beans at a ratio of 60% coffee beans to 40% coffee oil. These two components were mixed for five minutes by hand at ambient temperature conditions. The resulting mixture was passed through a 3-roll refiner, utilising a roller pressure of 10 bar and gap settings of 12:30 between the first and second roller, and 12:15 between the second and third rollers. Using the above process, a low product yield of approx. 50% was achieved, and the particle size distribution of the coffee particles was D90<160 μm, D50<27 μm and D10<4 μm.

### Further Trials

### Ingredients:

Kenco Medium Dark Roast Whole Beans (100% Arabica)
Pressed Coffee Oil (CM Oil)
Coconut Oil

### Equipment & Analytical Method References:

Cuisinart Burr Mill (18 cup capacity) coffee grinder
Hobart Planetary Mixer
Buhler 3 roll refiner
Malvern Mastersizer 2000 (Reference method: TM-165/KJS-780, based on ISO 13320:2009)

### Trial Protocol

For all the following experiments, the following process was followed:
1) Coffee beans were pre-ground using the Cuisinart Burr Mill coffee grinder on the finest setting. Resulting grind size was d10=250 μm, d50=617 μm, d90=997 μm.
2) Ground coffee was mixed with an amount of oil (coffee or coconut) in the Hobart mixer (no temperature control) for a prescribed length of time, or 5 minutes if not defined.
3) The resulting paste was passed through the refiner, with gap size, pressure and temperature defined.
4) For some experiments, steps 2 and/or 3 were repeated with the product from step 3 being used in the place of ground coffee.
5) Samples were taken at the end of steps 3 and/or 4, and analysed for particle size. Losses and throughput were estimated for each experiment.

Note that the initial grind size of the roast coffee beans is much larger than used in Example 1, due to constraints of local equipment. Previous trials used roast ground coffee which achieved a particle size with d90=280 μm.

Roller Refined products were then dry-blended with soluble coffee to simulate a finished product composition, and made into brews with a 1.5% solids concentration. The samples were compared for differences in appearance of surface oil and flavour/mouthfeel attributes.

The brew compositions were as follows:

| | 5% Roller | 15% Roller |
|---|---|---|
| | Product | Product |
| Roller Milled product | 0.075 g | 0.225 g |
| FD Soluble coffee | 1.425 g | 1.275 g |
| Water (85° C.) | 98.5 g | 98.5 g |

### Impact of Refiner Settings

In order to assess the impact of refiner process settings on the coffee product, a series of samples were generated. The parameters of interest were: gap size between pairs of rollers, difference in gap size, roller pressure and knife pressure. For all samples in this set, 20% coffee oil was combined with 80% pre-ground coffee for 5 minutes in an ambient Hobart mixer.

| | Roller | | | | | | |
|---|---|---|---|---|---|---|---|
| | ½ | Roller | Roller | Knife | Particle | | |
| Exp | gap | ⅔ gap | pressure | pressure | size (μm) | Throughput | Consistency |
| 1 | 12:20 | 12:15 | 10 bar | 10 bar | 62.7 | 50% loss of | Compressible |
| | | | | | | product | powder |
| 3 | 12:15 | 12:10 | 10 bar | 10 bar | 54.4 | 50% loss of | Compressible |
| | | | | | | product | powder |
| 2 | 12:10 | 12:05 | 10 bar | 10 bar | 62.0 | 50% loss of | Compressible |
| | | | | | | product | powder |
| 4 | 12:05 | 12:00 | 10 bar | 10 bar | 65.8 | 50% loss of | Compressible |
| | | | | | | product | powder |

Decreasing the gap size (with a 5 minute difference between roller pairs) did not significantly reduce the particle size of the roller refined coffee, or impact processability.

| | Roller | | | | | | |
|---|---|---|---|---|---|---|---|
| | ½ | Roller | Roller | Knife | Particle | | |
| Exp | gap | ⅔ gap | pressure | pressure | size (μm) | Throughput | Consistency |
| 5 | 12:20 | 12:15 | 15 bar | 10 bar | 62.2 | 100% | Compressible |
| | | | | | | throughput | powder |
| 7 | 12:15 | 12:15 | 15 bar | 10 bar | 64.1 | 100% | Compressible |
| | | | | | | throughput | powder |
| 8 | 12:05 | 12:05 | 15 bar | 10 bar | 64.8 | 100% | Compressible |
| | | | | | | throughput | powder |

Increasing the pressure and reducing the gap size (irrespective of any difference between roller pairs) did not significantly reduce the particle size of the roller refined coffee, but reduced the losses of product compared to 10 bar roller pressure.

### Paste Preparation

A series of products were generated where the refining process conditions were maintained, but the length of time mixing the pre-ground coffee with the coffee oil was changed. Refiner settings were the same as for sample 8.

| | Amount of | Length of | Particle | | |
|---|---|---|---|---|---|
| | coffee oil | paste | size | | |
| Exp. | (%) | mixing | (μm) | Throughput | Consistency |
| 8 | 20 | 5 mins | 64.8 | 100% | Compressible |
| | | | | throughput | powder |
| 9 | 20 | 10 mins | 63.3 | Better roll | Compressible |
| | | | | coverage | powder |
| | | | | than 8 | |
| 10 | 20 | 15 mins | 60.5 | Better roll | Compressible |
| | | | | coverage | powder |
| | | | | than 8, no | |
| | | | | improvement | |
| | | | | from 9 | |

Increasing the length of time of mixing the coffee and coffee oil did not significantly reduce the particle size of the roller refined coffee, but improved processability. 10 minutes is preferred mixing time to 5 minutes.

### Impact of One Versus Two Passes Through the Refiner

A roller refiner product was generated, which was then passed through the refiner using the same settings a second time.

| | | Number of | | | |
|---|---|---|---|---|---|
| | Amount of | passes | Particle | | |
| | coffee oil | through | size | | |
| Exp. | (%) | refiner | (μm) | Throughput | Consistency |
| 7 | 20 | One | 64.1 | No losses | Compressible |
| | | | | in tray | powder |
| 14 | 20 | Two | 48.1 | Faster | Second pass |
| | | | | throughput | product is |
| | | | | on second | smooth and |
| | | | | pass | dense flake |

Passing the material through the rollers at the same settings for a second time achieved a smaller particle size and more homogeneous product. This indicates there would be a benefit of either starting with a smaller pre-grind particle size, and/or using five rollers instead of three.

### Initial Paste Consistency

Samples were generated by a single pass through the roller refiner. The level of oil in the product is detailed below with the sensory findings, as compared to a standard of Kenco Really Rich (KRR) which contains no R&G particles:

| | % Oil in | Particle | | Paste | |
|---|---|---|---|---|---|
| Exp. | paste | size (μm) | Throughput | consistency | Sensory comments |
| 20 | 10 | 56.3 | No losses, | Dry powder | Similar bitter taste to |
| | | | fast | | KRR |
| 21 | 15 | 58.5 | No losses | Compressible | N/A |
| | | | | powder | |
| 8 | 20 | 64.8 | No losses | Compressible | Milder, more rounded |
| | | | | powder | flavour |
| 22 | 25 | 51.0 | No losses | A little | N/A |
| | | | | separation of fat | |
| | | | | from paste | |
| 23 | 30 | 56.1 | No losses | Separation of fat | Much milder flavour |
| | | | | from paste | than KRR, oil starts to |
| | | | | | appear on brew |
| | | | | | surface |
| 24 | 40 | 31.9 | Slower | Strong | N/A |
| | | | throughput | separation of fat | |
| | | | | from paste | |
| 25 | 60 | 30.9 | Very slow | Liquid/solid | Bitter after-taste, |
| | | | | separation | significant expression |
| | | | | | of oil on brew surface |
| 26 | 80 | 25.4 | Extremely | Liquid with some | N/A |
| | | | slow | solid parts | |

Increasing oil content beyond 30% coffee oil had a negative impact on throughput. However, much finer particle sizes were achieved in a single pass as oil contents of 40% and higher (likely to be due to long residence time on first roller).

### Second Paste Consistency

A series of samples were generated where a roller refined product (one pass through) was further mixed with an amount of oil and pass through the rollers for a second time. The factor of interest was the amount of oil added to the refined coffee, and how this impacted the processing and quality of the final roller refined product. All the samples in this set used from sample 16 (one pass through refiner of 80% coffee: 20% coffee oil starting mix) as their starting material.

| | Amount of | Total | | | |
|---|---|---|---|---|---|
| | coffee oil | oil | Particle | | |
| | added second | content | size | | |
| Exp. | time (%) | (%) | (μm) | Throughput | Consistency |
| 18 | 0 | 20 | 26.2 | Good | Compressible |
| | | | | throughput | paste |
| 19 | 2.5 | 22.5 | 39.0 | Fair | Some fat |
| | | | | throughput | expression |
| 17 | 14.2 | 34.2 | 29.9 | Slow, no | Lots of fat |
| | | | | losses | expression |

Passing the roller product through the refiner for a second time significantly reduced the particle size. Adding an amount of oil to the paste prior to the second pass did not have a benefit on particle size reduction, and had a negative impact on throughput and product consistency.

### Fat Type

A series of products were produced to compare the impact on processing and finished product of fat type. Coconut oil was selected as it would not impart coffee attributes to the finished product, and was a solid at ambient temperatures (as opposed to coffee oil which is liquid).

It was found that a similar particle size, throughput and product consistency were achieved for coffee oil and coconut oil, when trialled using the same settings.

| | | Roller | | | Appearance | |
|---|---|---|---|---|---|---|
| | Oil type | Temp. | Particle | | of oil in | Sensory |
| Exp | & % | (° C.) | size (μm) | Throughput | brew | comments |
| 18 | Coffee | 22 | 26.2 | No losses | Low | Astringent, very |
| | oil, 20% | | | | | oily mouthfeel |
| 30 | Coconut | 35 | 27.6 | Better roll | Low | Less intense |
| | oil, 20% | | | coverage | | aroma, less |
| | | | | than coffee | | astringent than |
| | | | | oil | | 18 |

Coconut oil appears to mask the flavour attributes of soluble coffee more than coffee oil. A potential benefit of increasing roller temperature to 35° C. was seen with coconut oil, as throughput was improved and better roll coverage was achieved.

### Impact of Finished Product Preparation Method

Sample 19 was made up to a finished product as a dry dispersion, as previously described, but also in a wet-dispersion method as follows.
Concentrated coffee extract was reconstituted by dissolving KRR soluble coffee in cold water at 50% solids
Roller refined product was added to the extract and dispersed with a Silverson mixer for 1 minute at 1000 rpm
Resultant coffee product was made into a coffee brew with hot water at a 1.5% solids concentration

| Dispersion | Appearance | |
|---|---|---|
| method | of oil in brew | Sensory comments |
| Dry | Medium | Poor dispersion of roller product in brew, |
| | | lumpy in sediment. Little crema generated. |
| Wet | Very low | Dark brown crema was generated in the |
| | | brew, smooth flavour profile, no visible |
| | | particles in sediment |

It is less preferred to dry-blend the roller refined product with soluble coffee to make a brew. Roller refined product must be suitably dispersed in an aqueous system eg concentrated coffee extract to ensure acceptable delivery in the brew.

### CONCLUSIONS

When using a lab-scale 3-roll refiner the greatest particle size reduction possible with a single pass through the refiner is d90<50 μm. For particle sizes of d90<35 μm, two passes are recommended.

It is less preferred to use the dry dispersion method to prepare finished product samples unless roller refined product is very fresh. It is recommended that all sensory assessments are carried out on brews made from a wet-dispersion method.

Initial oil contents of 10-30% are acceptable to process. Adding further oil to the product prior to a second pass through the refiner has a negative impact on throughput at amounts >2.5%. No additional oil is required to permit a second pass to be achieved. The optimum formulation combination seems to be 20% oil in the initial paste, with two passes (no additional oil or mixing between passes).

Table of Trial Examples

| Ex | Formulation | Settings | PSD | Comments | Impact |
|---|---|---|---|---|---|
| 1 | 80% coffee 20% coffee oil, | 12:20/12:15 | 62.7 | 50% loss in tray | At 10 bar no impact of |
| | 5 mins mix | 10 bar | | 2SD = 9.9 | changing gap size with |
| 2 | 80% coffee 20% coffee oil, | 12:10/12:05 | 62.0 | 50% loss in tray | single pass |
| | 5 mins mix | 10 bar | | 2SD = 4.9 | |
| 3 | 80% coffee 20% coffee oil, | 12:15/12:10 | 54.4 | 50% loss in tray | |
| | 5 mins mix | 10 bar | | Very consistent PSDs | |
| | | | | (2SD = 0.52) | |
| 4 | 80% coffee 20% coffee oil, | 12:05/12:00 | 65.8 | 50% loss in tray | |
| | 5 mins mix | 10 bar | | 2SD = 4.6 | |
| 5 | 80% coffee 20% coffee oil, | 12:20/12:15 | 62.15 | No losses in tray. | Increased pressure |
| | 5 mins mix | 15 bar | | Less large | improves throughput. |
| | | | | particles. | Still no impact of |
| | | | | 2SD = 5.64 | changing gap size at |
| 6 | Pre-ground coffee (oil | N/A | 716 | Two populations: | higher pressure. |
| | dispersion method) | | | 500 um and 30 um. | |
| 7 | 80% coffee 20% coffee oil, | 12:15/12:15 | 64.06 | No losses in tray. | |
| | 5 mins mix | 15 bar | | Sharp cut-off at 300 um | |
| | | | | 2SD = 4.98 | |
| 8 | 80% coffee 20% coffee oil, | 12:05/12:05 | 64.81 | No losses in tray | |
| | 5 mins mix | 15 bar | | 2SD = 7.93 | |
| 9 | 80% coffee 20% coffee oil, | 12:05/12:05 | 63.28 | Better adherence to | Impact of mixing time |
| | 10 mins mix | 15 bar | | rolls than 5 mins | |
| | | | | 2SD = 7.07 | |
| 10 | 80% coffee 20% coffee oil, | 12:05/12:05 | 60.46 | Better adherence to | |
| | 15 mins mix | 15 bar | | rolls than 5 mins | |
| | | | | 2SD = 7.01 | |
| 11 | Pre-ground coffee (air | N/A | 997.3 | N/A | |
| | dispersion) | | | | |
| 12 | 90% coffee 10% coffee oil, | 12:05/12:05 | 46.62 | Slow throughput, no | Impact of % fat |
| | 10 mins mix | 15 bar | | losses in tray | |
| | | | | Creates a freely flowing | |
| | | | | powder. 2SD = 4.71 | |
| 13 | 70% coffee 30% coffee oil, | 12:05/12:05 | 43.92 | Inhomogeneous product, lots | |
| | 10 mins mix | 15 bar | | of fat expression. Very dense | |
| | | | | product, lumpy. 2SD = 2.39 | |
| 14 | 1) 80% coffee 20% coffee | 1&2: 12:15/12:15, | 48.12 | Good throughput, product | Impact of |
| | oil, 10 mins mix | 15 bar | | has smooth texture, dark | second pass= |
| | 2) 0% oil, no mix | | | dense appearance | |
| 15 | 1) 80% coffee 20% coffee | 1&2: 12:15/12:15, | 43.55 | Very smooth product, forms | |
| | oil, 10 mins mix | 15 bar | | a flake shape on knife, more | |
| | 2) 1% oil, 10 min mix | | | pasty/viscous than 14. VERY | |
| | | | | good throughput. | |
| 16 | 1^{st} pass only 80% coffee, | 12:15/12:15, | 66.9 | | |
| | 20% coffee oil | 15 bar | | | |
| | | pressure (10 | | | |
| | | bar knife) | | | |
| N/A | 1) 80% coffee 20% coffee | 1: 12:15/12:15, | | No throughput, no product | |
| | oil, 10 mins mix | 2. 12.05/12:05 | | collected. | |
| | 2) 5% oil, 10 min mix | 1&2: 15 bar | | | |
| 17 | 1) 80% coffee 20% coffee | 1: 12:15/12:15, | 29.9 | Slow throughput, lots of fat | |
| | oil, 10 mins mix | 2. 12:05/12:05 | | expression, hard to collect | |
| | 2) 14.2% oil, 10 min mix | 1&2: 15 bar | | sample | |
| 19 | 1) 80% coffee 20% coffee | 1: 12:15/12:15, | 39.0 | Fat expression | |
| | oil, 10 mins mix | 2. 12:05/12:05, | | | |
| | 2) 2.5% oil, 10 min mix | 10 bar (2 bar knife) | | | |
| 18 | 1) 80% coffee 20% coffee | 1: 12:15/12:15, | 26.2 | Good throughput | |
| | oil, 10 mins mix | 2. 12:05/12:05, | | | |
| | 2) No oil, no mix | 10 bar (2 bar knife) | | | |
| 20 | 90% coffee 10% coffee oil, | 12:05/12:05 | 56.3 | | Low PSD shoulder |
| | 10 mins mix | 15 bar | | | |
| 21 | 85% coffee 15% coffee oil, | 12:05/12:05 | 58.5 | | Low PSD shoulder |
| | 10 mins mix | 15 bar | | | |
| 22 | 75% coffee 25% coffee oil, | 12:05/12:05 | 51.0 | Some oil expression/ | Low PSD shoulder |
| | 10 mins mix | 15 bar | | inhomogeneity | |
| 23 | 70% coffee 30% coffee oil, | 12:05/12:05 | 56.1 | High fat expression, | Low PSD shoulder, |
| | 10 mins mix | 15 bar | | better throughput | some large particles |
| | | | | | (4-500 um) |
| 24 | 60% coffee, 40% coffee oil | 12:05/12:05 | 31.9 | | |
| | | 10 bar (2 bar knife) | | | |
| 25 | 40% coffee, 60% coffee oil | 12:05/12:05 | 30.9 | Slow throughput, runny | No shoulder. |
| | | 10 bar (2 bar knife) | | product | D99 < 55 um |
| 26 | 20% coffee, 80% coffee oil | 12:05/12:05 | 25.4 | Very slow throughput, | No shoulder |
| | | 10 bar (2 bar knife) | | very runny product | D99 < 50 um |
| 27 | 80% coffee, 20% coconut oil | 1 pass at | 66.3 | | |
| | | 12:15/12:15, | | | |
| | | 10 bar | | | |
| 28 | 27 starter material, no | 2^{nd} pass @ | 50.3 | | Low PSD shoulder |
| | extra fat | 15 bar, | | | |
| | | 12:05/12:05 | | | |
| 29 | 27 starter material, no | 2^{nd} pass @ | 39.9 | | Low PSD shoulder |
| | extra fat | 20 bar, | | | |
| | | 12:05/12:05 | | | |
| 30 | 27 starter material, no | 2^{nd} pass @ | 27.6 | Fat expressed in the | D99 < 40 um |
| | extra fat | 20 bar, | | tray | |
| | | 12:05/12:05, | | | |
| | | 35 C. rollers | | | |

Although preferred embodiments of the invention have been described herein in detail, it will be understood by those skilled in the art that variations may be made thereto without departing from the scope of the invention or of the appended claims.

1. A process for the manufacture of a roast and ground coffee powder, the process comprising the steps of:
mixing roast and ground coffee with additional coffee oil; and
roller-grinding the mixture to a roast and ground coffee particle size having a D90 of 80 microns or less.

2. The process according to claim 1 for the manufacture of an additive for a beverage powder.

3. The process according to claim 2, wherein the beverage powder is a soluble coffee.

4. The process according to claim 1, wherein, in the step of mixing the roast and ground coffee with additional coffee oil, the roast and ground coffee has a particle size having a D50 of from 0.2 to 1.5 mm.

5. The process according to claim 1, wherein the mixture is roller-ground to a roast and ground coffee particle size having a:
D90 of less than 60 microns, preferably from 30 to 60 microns; and/or
D50 of from 5 to 30 microns, preferably 10 to 20 microns; and/or
D10 of from 0.1 to 10 microns, preferably 1 to 5 microns.

6. The process according to claim 1, wherein the additional coffee oil is pressed coffee oil, waste coffee oil and/or oil extracted from spent coffee beans.

7. The process according to claim 1, wherein the coffee oil includes one or more added aroma compounds

8. The process according to claim 1, wherein the roller-grinding is performed using two or more smooth rollers.

9. The process according to claim 1, wherein the roller grinding is performed at ambient temperature.

10. The process according to claim 1, wherein the step of mixing roast and ground coffee with additional coffee oil further comprises mixing with a further beverage ingredient.

11. The process according to claim 10, wherein the further beverage ingredient is selected from milk powder, sugar, sweeteners, chocolate powder, a flavouring ingredient, a foaming ingredient, or a combination of two or more thereof.

11. The process according to claim 1, wherein the mixing ratio of roast and ground coffee to additional coffee oil is 9:1 to 3:2, preferably about 4:1.

12. The process according to claim 1, the process further comprising mixing the roast and ground coffee powder into a dessert, ice-cream, sauce, chocolate, mousse or biscuit dough.

13. An additive for a beverage powder, preferably an additive for soluble coffee, obtainable by the process of claim 1.

14. A process for the manufacture of a roast-and-ground-coffee-containing beverage powder, the process comprising the steps of:
(A) mixing an additive produced according to claim 1 with a beverage powder; or
(B) mixing an additive produced according to claim 1 with an aqueous beverage formulation to form a mixture and drying the mixture.

15. The process according to claim 14, wherein the beverage powder is soluble coffee, milk powder, chocolate powder, creamer powder, tea powder, or a combination of two or more thereof.

16. A process according to claim 14, wherein the step of drying the mixture is spray-drying or freeze-drying.

17. A process according to claim 14, the process comprising agglomerating the beverage powder and/or forming the beverage powder into a tablet.

18. A process according to claim 14, the process further comprising a step of packaging the beverage powder or beverage tablet.

19. A method of preparing a beverage, the method comprising adding a beverage medium to the roast-and-ground-coffee-containing beverage powder manufactured according to claim 13.
